(19) United States
(12) Patent Application Publication
(10) Pub. No.: US 2022/0003841 A1
(43) Pub. Date: Jan. 6, 2022

(54) DYNAMIC LASER POWER CONTROL FOR LIDAR SYSTEM

(71) Applicant: BEIJING VOYAGER TECHNOLOGY CO., LTD., Beijing (CN)

(72) Inventors: Yu-Ching Yeh, Mountain View, CA (US); Yue Lu, Mountain View, CA (US)

(73) Assignee: BEIJING VOYAGER TECHNOLOGY CO., LTD., Beijing (CN)

(21) Appl. No.: 16/920,650

(22) Filed: Jul. 3, 2020

(51) Int. Cl. G01S 7/484; G01S 17/89; G01S 17/931; G01S 7/481; G01N 21/55

(52) U.S. Cl. CPC G01S 7/484; G01S 17/89; G01N 21/55; G01S 7/4817; G01S 7/4814; G01S 17/931

(57) ABSTRACT

Embodiments of the disclosure provide an optical sensing system, a method for controlling an emitting power level in the optical sensing system, and a control apparatus for controlling the emitting power level in the optical sensing system. The exemplary optical sensing system includes a transmitter configured to emit light beams at a plurality of vertical detection angles to scan an object. The optical sensing system further includes a controller configured to dynamically vary an emitting power level of the light beams emitted at the respective vertical detection angles. The optical sensing system also includes a receiver configured to detect the light beams returned by the object.

### TECHNICAL FIELD

The present disclosure relates to laser power control for a light detection and ranging (LiDAR) system, and more particularly to, dynamic laser power control to compensate for the change of detection distance at different vertical detection angles of the LiDAR system.

### BACKGROUND

Optical sensing systems such as LiDAR systems have been widely used in advanced navigation technologies, such as to aid autonomous driving or to generate high-definition maps. For example, a typical LiDAR system measures the distance to a target by illuminating the target with pulsed laser light beams and measuring the reflected pulses with a sensor such as a detector or a detector array. Differences in laser light return times, wavelengths, and/or phases can then be used to construct digital three-dimensional (3D) representations of the target. Because using a narrow laser beam as the incident light can map physical features with very high resolution, a LiDAR system is particularly suitable for applications such as sensing in autonomous driving and high-definition map surveys.

The pulsed laser light beams emitted by a LiDAR system are typically directed to multiple directions to cover a field of view (FOV). For example, the vertical detection angle (known as the look-down angle when the scanning laser beam points downward) of the LiDAR system varies to scan objects in a vertical space. The required detection distance varies with the vertical detection angle. For instance, when the look-down angle is small, i.e., LiDAR emits scanning laser beam nearly horizontally, the distance toward an object is longer. On the other hand, with an increasing looking-down angle, the distance toward the ground is shorter.

Conventional LiDAR systems use a constant laser emitting power for different vertical detection angles. That causes several problems. First, laser beams reflected by objects at shorter distance (e.g., near the ground) may carry higher power and cause saturation on the receiver end, thus impairing the scan accuracy. Increase of operating temperature as a result of the high power could reduce thermal performance of the system. In addition, the high-power laser beams may impose eye-safety concerns for pedestrians near the LiDAR scanning zone. Using a constant power at different vertical angles also hurts efficiency in overall system power consumption.

Embodiments of the disclosure improve the performance of optical sensing systems such as LiDAR systems by implementing a dynamic laser power control to compensate for the change of detection distance at different vertical detection angles of the sensing system.

### SUMMARY

Embodiments of the disclosure provide an optical sensing system. The exemplary optical sensing system includes a transmitter configured to emit light beams at a plurality of vertical detection angles to scan an object. The optical sensing system further includes a controller configured to dynamically vary an emitting power level of the light beams emitted at the respective vertical detection angles. The optical sensing system also includes a receiver configured to detect the light beams returned by the object.

Embodiments of the disclosure also provide a method for controlling an emitting power level in an optical sensing system. The method includes emitting, by a transmitter, light beams at a plurality of vertical detection angles to scan an object. The method further includes dynamically varying, by a controller, the emitting power level of the light beams at the respective vertical detection angles. The method also includes detecting, by a receiver, the light beams returned by the object.

Embodiments of the disclosure further provide a control apparatus for controlling an emitting power level in an optical sensing system. The control apparatus includes a driver circuit configured to drive an emitter of the optical sensing system to emit light beams. The light beams are emitted at a plurality of vertical detection angles. The control apparatus further includes a controller configured to control the driver circuit to dynamically vary the emitting power level of the light beams emitted at the respective vertical detection angles.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2 illustrates a block diagram of an exemplary LiDAR system, according to embodiments of the disclosure.

FIG. 3 illustrates a schematic diagram of an exemplary controller for adjusting laser power of a LiDAR system, according to embodiments of the disclosure.

FIG. 4 illustrates vertical detection angles used during a LiDAR scan and corresponding detection distances, according to embodiments of the disclosure.

FIG. 5 illustrates exemplary emitter driver circuits for adjusting laser power of a LiDAR system, according to embodiments of the disclosure.

FIG. 6 is a flow chart of an exemplary method for adjusting laser power of a LiDAR system, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provide systems and methods for dynamically controlling the emitting power level in an optical sensing system (e.g., a LiDAR system). For example, the optical sensing system may include a transmitter configured to emit light beams (e.g., laser beams) at a plurality of vertical detection angles to scan an object. At smaller vertical detection angles, the detection distance is longer while at larger vertical detection angles, the detection distance shortens. In some embodiments, the optical sensing system includes a controller configured to dynamically vary an emitting power level of the light beams emitted at the respective vertical detection angles. For example, the emitting power level may be adjusted according to the detection distances at the various vertical detection angles, as shorter detection distances warrant use of less laser power. In some embodiments, the emitting power level can be proportional to a square of the detection distances. In some further embodiments, the emitting power level is also proportional to a ratio of the reflectivity of the object and the reflectivity of the ground. As another example, the controller may determine a threshold angle based on an elevation of the optical sensing system positioned above a ground and a threshold detection distance of the optical sensing system. The controller then reduces the emitting power level when the vertical detection angle is larger than the threshold angle.

In some embodiments, the transmitter may further include an emitter configured to emit the light beams and a driver circuit (e.g., a FET-controlled driver circuit or a capacitive discharge driver circuit) configured to drive the emitter to emit the light beams at the dynamically varying emitting power level. For example, the controller is configured to supply a voltage command signal to the driver circuit and the driver circuit is configured to supply a varying driver current to the emitter in response to the voltage command signal. In some embodiments, the controller is configured to change an amplitude or a pulse width of the voltage command signal so that the varying driver current is proportional to the desired emitting power level. The emitted light beams are reflected and returned from the object being scanned, and received by a receiver of the optical sensing system.

By dynamically and adaptively varying the emitting power level, embodiments of the present disclosure therefore improve the performance of an optical sensing system. For example, system power consumption can be more efficiently distributed over the different vertical viewing angles. This not only saves total system power but also improves eye safety for regions close to ground. On the other hand, reducing output power also benefits thermal efficiency and laser efficiency of the system. The improved optical sensing system can be used in many applications. For example, the improved optical sensing system can be used in advanced navigation technologies, such as to aid autonomous driving or to generate high-definition maps, in which the optical sensing system can be equipped on a vehicle.

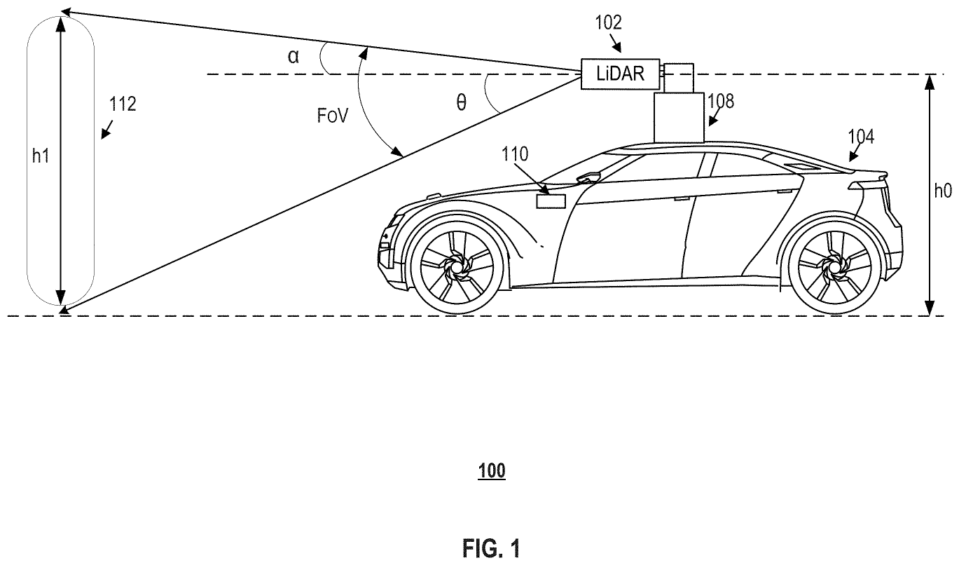

For example, FIG. 1 illustrates a schematic diagram of an exemplary vehicle 100 equipped with an optical sensing system (e.g., a LiDAR system) 102 (hereinafter also referred to as LiDAR system 102), according to embodiments of the disclosure. Consistent with some embodiments, vehicle 100 may be a survey vehicle configured for acquiring data for constructing a high-definition map or 3-D buildings and city modeling. Vehicle 100 may also be an autonomous driving vehicle.

As illustrated in FIG. 1, vehicle 100 may be equipped with LiDAR system 102 mounted to a body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve desirable 3D sensing performance.

Consistent with some embodiments, LiDAR system 102 and sensor 110 may be configured to capture data as vehicle 100 moves along a trajectory. For example, a transmitter of LiDAR system 102 may be configured to scan the surrounding environment. LiDAR system 102 measures distance to a target by illuminating the target with a pulsed laser beam and measuring the reflected/scattered pulses with a receiver. The laser beam used for LiDAR system 102 may be ultraviolet, visible, or near infrared. In some embodiments of the present disclosure, LiDAR system 102 may capture point clouds including depth information of the objects in the surrounding environment. As vehicle 100 moves along the trajectory, LiDAR system 102 may continuously capture data. Each set of scene data captured at a certain time range is known as a data frame.

In some embodiments, LiDAR system 102 may be mounted at a certain elevation (e.g., h₀ as shown in FIG. 1) above the ground such that it can scan objects at a range of heights using laser beams emitted at different vertical detection angles. For example, FIG. 1 shows a field of view (FOV) consisting of a range of vertical detection angles to cover an object 112 up to h₁ in height above the ground. A vertical detection angle of a laser beam pointing upward relative to the horizontal direction (e.g., angle α as shown in FIG. 1) may be referred to as a look-up angle, and a vertical detection angle of a laser beam pointing downward relative to the horizontal direction (e.g., angle θ as shown in FIG. 1) may be referred to as a look-down angle.

In some embodiments, the vertical detection angle of LiDAR system 102 may be adjusted by mounting structure 108 and/or the scanner within LiDAR system 102. In some embodiments, the vertical detection angle may also be impacted by the pose of vehicle 100, e.g., whether vehicle 100 is traveling uphill or downhill. When the look-down angle θ is larger than a certain value, the laser beam emitted by LiDAR system 102 may impinge on the group and the corresponding detection distance may be smaller than the maxim detection distance. In such cases, because the laser beam travels for a shorter distance, it is less attenuated and the remaining power in the returned laser beam is higher. Consistent with the present disclosure, LiDAR system 102 is configured to dynamically and adaptively adjust the emitting power level of the laser beams it emits during scan, in a way to compensate for the shorter detection distances at larger vertical detection angles θ.

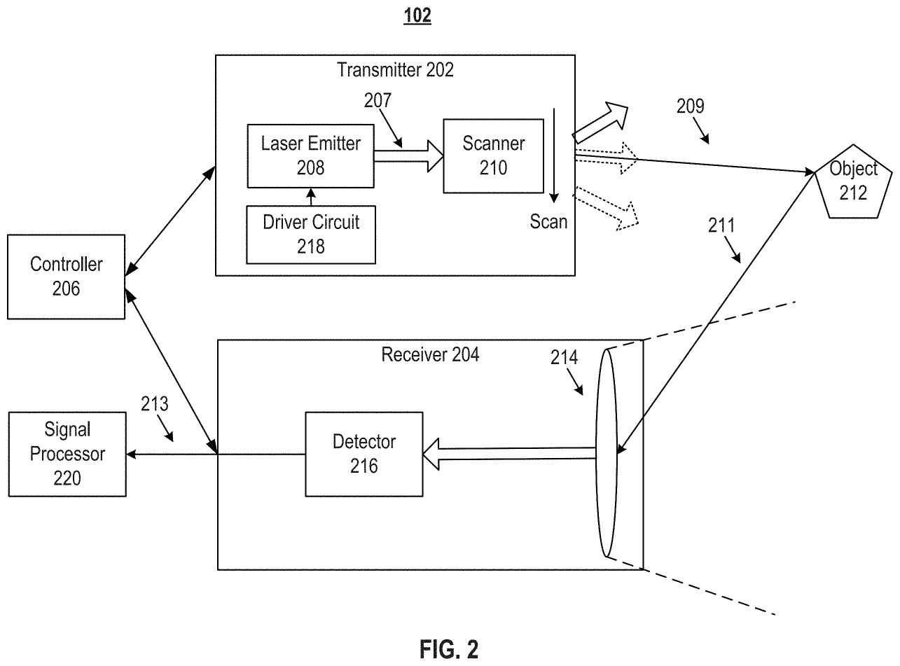

FIG. 2 illustrates a block diagram of an exemplary LiDAR system 102, according to embodiments of the disclosure. LiDAR system 102 may include a transmitter 202, a receiver 204, and a controller 206. Transmitter 202 may emit optical beams (e.g., laser beams) along multiple directions. Transmitter 202 may include one or more laser sources (including a laser emitter 208 and a driver circuit 218) and a scanner 210. Transmitter 202 can sequentially emit a stream of pulsed laser beams in different directions within a scan FOV (e.g., a range in angular degrees), as illustrated in FIG. 2.

Laser emitter 208 may be configured to provide a laser beam 207 (also referred to as “native laser beam”) to scanner 210. In some embodiments of the present disclosure, laser source 208 may generate a pulsed laser beam in the ultraviolet, visible, or near infrared wavelength range. In some embodiments of the present disclosure, laser emitter 208 may include a pulsed laser diode (PLD), a vertical-cavity surface-emitting laser (VCSEL), a fiber laser, etc. For example, a PLD may be a semiconductor device similar to a light-emitting diode (LED) in which the laser beam is created at the diode's junction. In some embodiments of the present disclosure, a PLD includes a PIN diode in which the active region is in the intrinsic (I) region, and the carriers (electrons and holes) are pumped into the active region from the N and P regions, respectively. Depending on the semiconductor materials, the wavelength of incident laser beam 207 provided by a PLD may be smaller than 1,100 nm, such as 405 nm, between 445 nm and 465 nm, between 510 nm and 525 nm, 532 nm, 635 nm, between 650 nm and 660 nm, 670 nm, 760 nm, 785 nm, 808 nm, 848 nm, or 905 nm. It is understood that any suitable laser source may be used as laser source 206 for emitting laser beam 207.

Driver circuit 218 may provide power to laser emitter 208 to turn it on, thus driving the laser emitter. Consistent with embodiments of the present disclosure, driver circuit 218 may be controlled to adjust the emitting power level of laser emitter 208. For example, the driver current of driver circuit 218 may be varied in order for laser emitter 208 to emit laser beams at a varying emitting power level. In some embodiments, the varying driver current provided by driver circuit 218 is proportional to the dynamically varying emitting power level. Driver circuit 218 may be implemented using any suitable circuit topologies that could achieve the desired functions. For example, in some embodiments, driver circuit 218 may be a FET-controlled driver circuit or a capacitive discharge driver circuit.

Scanner 210 may be configured to emit a laser beam 209 to an object 212 in a range of vertical detection angles (collectively forming the FOV of transmitter 202 such as shown in FIG. 1). The vertical detection angles can be look-up angles (pointing upward from the horizontal direction) or look-down angles (pointing downward from the horizontal direction). In some embodiments, scanner 210 may also include optical components (e.g., lenses, mirrors) that can collimate pulsed laser light into a narrow laser beam to increase the scan resolution and the range to scan object 212.

In some embodiments, object 212 may be made of a wide range of materials including, for example, non-metallic objects, rocks, rain, chemical compounds, aerosols, clouds and even single molecules. The wavelength of laser beam 209 may vary based on the composition of object 212. In some embodiments, at each time point during the scan, scanner 210 may emit laser beam 209 to object 212 in a direction within a range of scanning angles by rotating a deflector, such as a micromachined mirror assembly.

In some embodiments, receiver 204 may be configured to detect a returned laser beam 211 returned from object 212. The returned laser beam 211 may be in a different direction from beam 209. Receiver 204 can collect laser beams returned from object 212 and output electrical signals reflecting the intensity of the returned laser beams. Upon contact, laser light can be reflected/scattered by object 212 via backscattering, such as Rayleigh scattering, Mie scattering, Raman scattering, and fluorescence. As illustrated in FIG. 2, receiver 204 may include a lens 214 and a detector 216. Lens 214 may be configured to collect light from a respective direction in the receiver field of view (FOV) and converge the light beam to focus on detector 216. At each time point during the scan, returned laser beam 211 may be collected by lens 214. Returned laser beam 211 may be returned from object 212 and have the same wavelength as laser beam 209.

Detector 216 may be configured to detect returned laser beam 211 returned from object 212 and converged by lens 214. In some embodiments, detector 216 may convert the laser light (e.g., returned laser beam 211) converged by lens 214 into an electrical signal 218 (e.g., a current or a voltage signal). Electrical signal 218 may be generated when photons are absorbed in a photodiode included in detector 216. In some embodiments, detector 216 may include a PIN detector, an avalanche photodiode (APD) detector, a single photon avalanche diode (SPAD) detector, a silicon photo multiplier (SiPM) detector, or the like.

Electrical signal 218 may be transmitted to a data processing unit, e.g., signal processor 220 of LiDAR system 102, to be processed and analyzed. For example, signal processor 220 may determine the distance of object 212 from LiDAR system 102 based on electrical signal 218 and data of laser beam 209. In some embodiments, signal processor 220 may be part of controller 206.

Controller 206 may be configured to control transmitter 202 and/or receiver 204 to perform detection/sensing operations. In some embodiments consistent with the present disclosure, controller 206 may dynamically determine an appropriate emitting power level of laser emitter 208 based on the vertical detection angle of LiDAR system 102 and control driver circuit 218 to adjust the emitting power of laser emitter 208 to the appropriate level. For example, controller 206 may determine the detection distances at the various vertical detection angles and calculate the desired emitting power level based on the detection distances. In some embodiments, the emitting power level can be proportional to a square of the detection distances. In some further embodiments, the emitting power level is also proportional to a ratio of the reflectivity of object 212 and the reflectivity of the ground. For example, controller 206 may determine the reflectivity of object 212 based on the returned laser beams received by receiver 204. In another example, controller 206 may determine a threshold angle based on an elevation of LiDAR system 102 positioned above the ground and a threshold detection distance of LiDAR system 102. Controller 206 may reduce the emitting power level when the vertical detection angle is larger than the threshold angle.

In some embodiments, controller 206 may control driver circuit 218 to dynamically vary the emitting power level of laser emitter 208 at the respective vertical detection angles. For example, controller 206 may supply a voltage command signal to driver circuit 218 so that the driver circuit supplies a varying driver current to laser emitter 208 in response to the voltage command signal provided by controller 206.

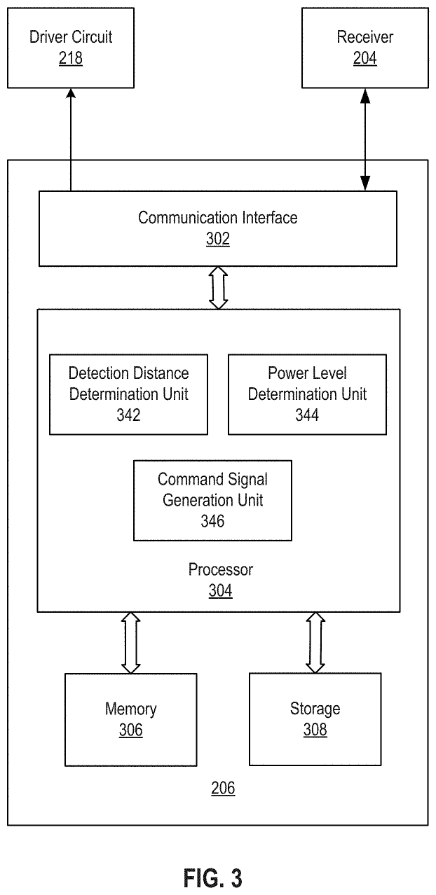

For example, FIG. 3 illustrates a schematic diagram of an exemplary controller 206 for adjusting laser power of a LiDAR system, according to embodiments of the disclosure. As shown by FIG. 3, controller 206 may include a communication interface 302, a processor 304, a memory 306, and a storage 308. In some embodiments, controller 206 may have different modules in a single device, such as an integrated circuit (IC) chip (e.g., implemented as an application-specific integrated circuit (ASIC) or a field-programmable gate array (FPGA)), or separate devices with dedicated functions. In some embodiments, one or more components of controller 206 may be located in a cloud or may be alternatively in a single location (such as inside a mobile device) or distributed locations. Components of controller 206 may be in an integrated device or distributed at different locations but communicate with each other through a network (not shown). Consistent with the present disclosure, controller 206 may be configured to dynamically control the emitting power level of the laser beams emitted by laser emitter 208 based on the different vertical detection angles of the emitted laser beams. In some embodiments, controller 206 may also perform various other control functions of other components of LiDAR system 102.

Communication interface 302 may send signals to and receive signals from components of transmitter 202 (such as driver circuit 218 and scanner 210) and receiver 204 via communication cables, a Wireless Local Area Network (WLAN), a Wide Area Network (WAN), wireless networks such as radio waves, a cellular network, and/or a local or short-range wireless network (e.g., Bluetooth™), or other communication methods. In some embodiments, communication interface 302 may include an integrated service digital network (ISDN) card, cable modem, satellite modem, or a modem to provide a data communication connection. As another example, communication interface 302 may include a local area network (LAN) card to provide a data communication connection to a compatible LAN. Wireless links can also be implemented by communication interface 302. In such an implementation, communication interface 302 can send and receive electrical, electromagnetic or optical signals in analog form or in digital form.

Consistent with some embodiments, communication interface 302 may receive electrical signals of returned laser beams from receiver 204. Communication interface 302 may provide control signals to driver circuit to dynamically adjust the emitting power level of the emitted laser beams. Communication interface 302 may also receive acquired signals from and provide control signals to various other components of LiDAR system 102.

Processor 304 may include any appropriate type of general-purpose or special-purpose microprocessor, digital signal processor, or microcontroller. Processor 304 may be configured as a separate processor module dedicated to LiDAR emitting power control, e.g., dynamically determining an appropriate emitting power level for the emitted laser beams based on their different vertical detection angles and generating control signals to control driver circuit 218 to effectuate that emitting power level. Alternatively, processor 304 may be configured as a shared processor module for performing other functions of LiDAR controls.

Memory 306 and storage 308 may include any appropriate type of mass storage provided to store any type of information that processor 304 may need to operate. Memory 306 and storage 308 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 306 and/or storage 308 may be configured to store one or more computer programs that may be executed by processor 304 to perform functions disclosed herein. For example, memory 306 and/or storage 308 may be configured to store program(s) that may be executed by processor 304 for dynamic LiDAR power control. In some embodiments, memory 306 and/or storage 308 may also store intermediate data such as threshold vertical detection angle, detection distances corresponding to the different vertical detection angles, reflectivity of the object being scanned, desired emitting power levels for the respective vertical detection angles, etc.

As shown in FIG. 3, processor 304 may include multiple modules, such as a detection distance determination unit 342, a power level determination unit 344, and a command signal generation unit 346, and the like. These modules can be hardware units (e.g., portions of an integrated circuit) of processor 304 designed for use with other components or software units implemented by processor 304 through executing at least part of a program. The program may be stored on a computer-readable medium, and when executed by processor 204, it may perform one or more functions. Although FIG. 3 shows units 342-346 all within one processor 304, it is contemplated that these units may be distributed among different processors located closely or remotely with each other.

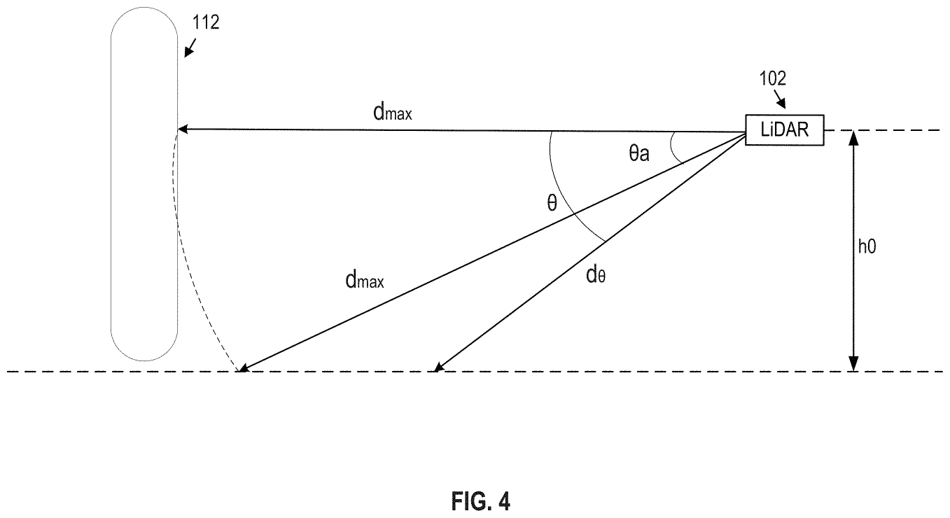

In some embodiments, detection distance determination unit 342 may calculate the detection distances corresponding to various vertical detection angles within the transmitter FOV. For example, FIG. 4 illustrates vertical detection angles used during a LiDAR scan and corresponding detection distances, according to embodiments of the disclosure. As shown in FIG. 4, LiDAR system 102 may locate at an elevation of h₀ above the ground plane. For example, LiDAR system 102 may be mounted on vehicle 100 and therefore lifted above the ground. LiDAR system 102 may have maximum detection distance dₘₐₓ (also referred to as a threshold detection distance), which corresponds to the horizontal distance between object 112 and LiDAR system 102. The maximum available output power level by laser emitter 208 at the maximum detection distance is Pₘₐₓ.

In some embodiments, the detection distance may be calculated as a function of the vertical detection angle (e.g., look-down angle θ as shown in FIG. 4). For example, the vertical detection angles may be determined based on the vertical scanning angles of scanner 210, the tilt angle of LiDAR system 102 (e.g., by mounting structure 108), and the elevation angle if the vehicle on which LiDAR system 102 is mount is traveling on a slope (e.g., uphill or downhill). In some embodiments, the vertical scanning angles of scanner 210 may be stored in controller 206 or obtained from another controller that controls the scanning of laser beams. The tilt angle and/or the elevation angle, if non-zero, are subtracted from the vertical scanning angles to obtain the vertical detection angles. For example, if the vertical scanning angle is 40°, LiDAR system 102 is mounted to be tilted upward for 10°, and vehicle 100 is traveling downhill on a slope of 15° (i.e., a −15° elevation angle), the vertical detection angle is determined as 40°−10°−(−15°)=45°.

In some embodiments, the detection distances may be calculated differently for vertical detection angles in two ranges: a first range of [0, θₐ], where θₐ is a threshold angle, and a second range of [θₐ, 90°). In some embodiments, the threshold angle θₐ may be determined according to Equation (1):

$${θ}_{a} = {sin}^{- 1} ( \frac{h 0}{{d}_{max}} ) \qquad ( 1 )$$

where h₀ is the elevation of LiDAR system 102 above the ground plane, and dₘₐₓ is the maximum detection distance.

When the vertical detection angle (e.g., look-down angle θ as shown in FIG. 4.) is smaller than θₐ (i.e., in the first range), the detection distance remains dₘₐₓ. When the look-down angle θ is larger than θₐ (i.e., in the second range), the detection distance d_{θ} becomes smaller. In some embodiments, the detection distance can be determined using Equation (2):

$${d}_{θ} = \frac{h 0}{sin θ} . \qquad ( 2 )$$

Based on the determined detection distances, power level determination unit 344 may calculate the appropriate emitting power level output by laser emitter 208. In some embodiments, for detection distances d_{θ} shorter than the maximum detection distance dₘₐₓ (i.e., for vertical detection angles θ larger than the threshold angle θₐ), power level determination unit 344 may reduce the emitting power level from the maximum available output power level Pₘₐₓ to a smaller but sufficient level. In some embodiments, the emitting power level may be proportional to a square of the respective detection distances. In some further embodiments, the emitting power level is proportional to a ratio of a first reflectivity of the target object and a second reflectivity of the ground. For example, power level determination unit 344 may calculate the emitting power level (P_{θ}) at look-down angle θ according to Equation (3):

$${P}_{θ} = {( \frac{{d}_{θ}}{{d}_{max}} )}^{2} \cdot \frac{{ρ}_{object}}{{ρ}_{ground}} \cdot {P}_{max} \qquad ( 3 )$$

where Pₘₐₓ is the maximum available output power level, ρ_{object} is the reflectivity of target object and ρ_{ground} is the reflectivity of ground plane, d_{θ} is the detection distance at look-down angle θ, and dₘₐₓ is the maximum detection distance. In some embodiments, the reflectivity of ground plane may be predetermined and preprogramed into controller 206. In some embodiments, the reflectivity of the target object (e.g., object 112) may be determined dynamically based on returned laser beam signals received by receiver 204 in real-time.

Once the emitting power level is determined, command signal generation unit 346 may generate a command signal to control driver circuit 218 in order to drive laser emitter 208 to emit laser beams at the determined emitting power level. In some embodiments, a voltage command signal may be generated and supplied to driver circuit 218. In response to the voltage command signal, driver circuit 218 may supply a varying driver current to laser emitter 208. In some embodiments, the varying driver current can be proportional to the emitting power level by laser emitter 208. Therefore, the emitted power level can be controlled by adjusting the voltage command signal generated by command signal generation unit 346.

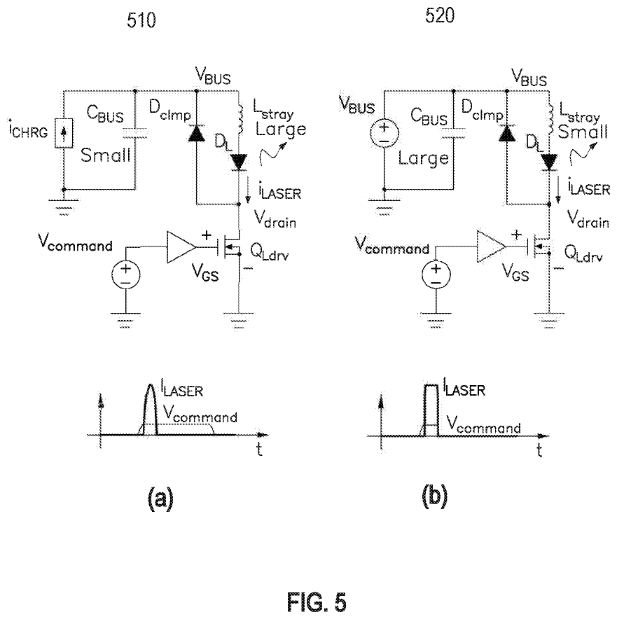

FIG. 5 illustrates exemplary emitter driver circuits for adjusting laser power of a LiDAR system, according to embodiments of the disclosure. In some embodiments, driver circuit 218 uses a semiconductor switch (e.g., gallium nitride (GaN) power FETs) that has a gate response (e.g., a driver current i_{LASER}) to the voltage command signal V_{command} applied by controller 206. The driver circuit may be connected in series with laser emitter 208 to supply the driver current i_{LASER} to flow through the laser diodes, causing laser beams to be emitted. The emitting power level by laser emitter 208 is general proportional to the product of amplitude and pulse width of the driver current supplied by driver circuit 218. Therefore, the emitted power level can be adjusted by applying appropriate control signals. For example, based on the desired emitting power level, command signal generation unit 346 may change one or more control signals applied to one or more components of driver circuit 218 to change an amplitude or a pulse width of the driver current. In some embodiments, the pulse width of the driver current can be controlled by the voltage command signal generated by command signal generation unit 346. In some other embodiments, amplitude of the driver current can be controlled by a controlling the supply voltage of driver circuit 218.

FIG. 5 shows an capacitive discharge driver circuit 510 and a FET-controlled driver circuit 520, as examples of driver circuit 218. It is contemplated that other suitable circuit topologies may be adopted by driver circuit 218. In some embodiments, capacitive discharge driver circuit 510 uses a small Cbus so Vbus varies over time as the capacitor charges and discharges. As a result, the gate response of FET, as shown by the diagram below the circuit, includes an impulsive driver current i_{LASER} with a pulse width narrower than that of V_{command}. In comparison, FET-controlled driver circuit 520 uses a large Cbus so that Vbus is almost constant. As a result, in the gate response shown by the diagram below the circuit, driver current i_{LASER} has a pulse width almost coincident with that of V_{command}. In some embodiments, capacitive discharge driver circuit 510 may be preferred for its faster switching and ability to accept stray inductance.

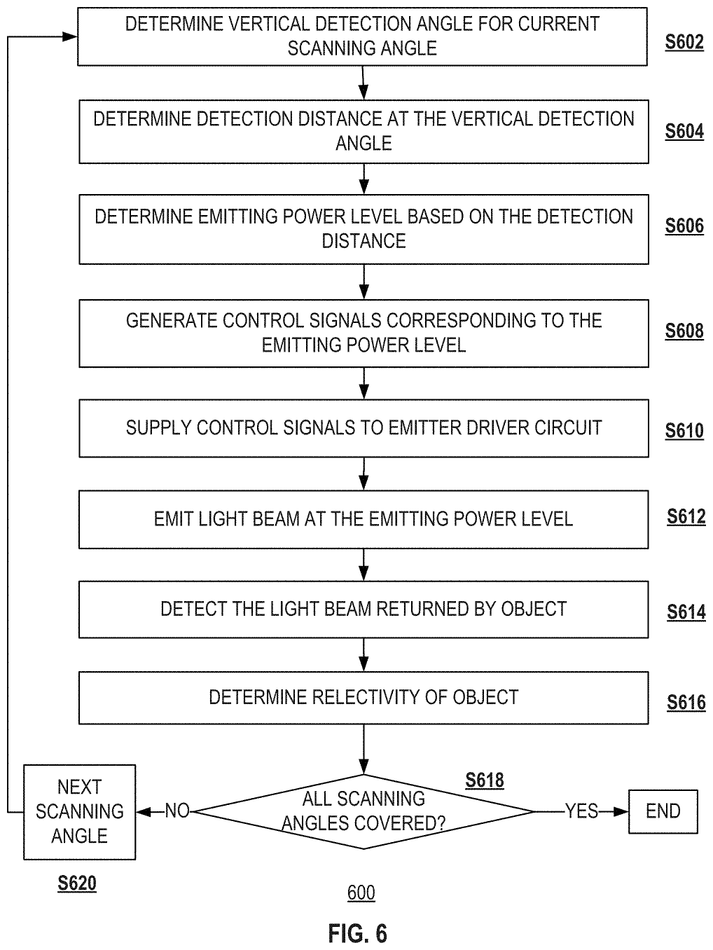

FIG. 6 is a flow chart of an exemplary method 600 for adjusting laser power of a LiDAR system, according to embodiments of the disclosure. In some embodiments, method 600 may be performed by various components of LiDAR system 102, e.g., transmitter 202, receiver 204, and controller 206. In some embodiments, method 600 may include steps S602-620. It is to be appreciated that some of the steps may be optional. Further, some of the steps may be performed simultaneously, or in a different order than shown in FIG. 6.

In step S602, controller 206 may determine the vertical detection angle for the current scanning angle. In some embodiments, controller 206 may receive the current scanning angle used by transmitter 202. In some embodiments, controller 206 may be the same controller that determines the scanning parameters and therefore have the parameters saved in its memory/storage. Therefore, controller 206 may retrieve the scanning angle from its own memory/storage. Otherwise, controller 206 may receive it from an external source. In some embodiments, detection distance determination unit 342 may first determine the current vertical detection angle based on the scanning angle, as adjusted by the tilt angle of LiDAR system 102, and the elevation angle if the vehicle is traveling on a slope.

In step S604, controller 206 may then calculate the detection distance corresponding to the current vertical detection angle. For example, when the vertical detection angle θ is smaller than a threshold angle θₐ calculated, e.g., according to Equation (1), detection distance determination unit 342 may determine the detection distance remains the maximum detection distance dₘₐₓ. When the angle θ is larger than θₐ, detection distance determination unit 342 may determine the detection distance using the elevation h₀ and a trigonometry of the angle θ, e.g., according to Equation (2).

In step S606, controller 206 may determine the emitting power level for the current scanning angle based on the detection distance determined in step S604. In some embodiments, for detection distances d_{θ} shorter than the maximum detection distance dₘₐₓ, power level determination unit 344 may reduce the emitting power level from the maximum available output power level Pₘₐₓ to a smaller but sufficient level. In some embodiments, the emitting power level may be proportional to a square of the respective detection distances. In some further embodiments, the emitting power level is proportional to a ratio of a first reflectivity of the target object and a second reflectivity of the ground. For example, power level determination unit 344 may calculate the emitting power level according to Equation (3).

In step S608, controller 206 may generate control signals to be applied to one or more components of driver circuit 218 corresponding to the emitting power level determined in step S606. In some embodiments, command signal generation unit 346 may generate control signals to cause driver circuit 218 to supply a driver current to laser emitter 208 to cause laser emitter 208 to emit laser beams at the determined emitting power level. Because the emitting power level is generally proportional to a product of the amplitude and the pulse width of the driver current, the control signals generated by command signal generation unit 346 may change an amplitude or a pulse width of the driver current. For example, command signal generation unit 346 may control the supply voltage (Vbus) of capacitive discharge driver circuit 510 or FET-controlled driver circuit 520, which is proportional to the amplitude of the driver current. As another example, command signal generation unit 346 may adjust the pulse width of a voltage command signal of FET-controlled driver circuit 520 to control the pulse width of the driver current. In generating the control signals, command signal generation unit 346 may consider the particular circuit topology implemented by driver circuit 218 and the corresponding gate response of the circuit.

In step S610, controller 206 may apply the control signals to the emitter driver circuit (e.g., driver circuit 218). The control signals adjust the driver current to be generated in the driver circuit. The driver current, when supplied to drive laser emitter 208, causes laser emitter 208 to emit laser beams. By adjusting the driver current, the controller signals control the emitting power level. In step S612, laser emitter 208 emits the light beam at the emitting power level determined in step S606.

In step S614, receiver 204 may detect the light beam returned by the target object. For example, receiver 204 may detect a returned laser beam 211 returned from object 212. Receiver 204 can collect laser beams returned from object 212 and output electrical signals reflecting the intensity of the returned laser beams. In step S616, controller 206 may determine the reflectivity of the target object based on the intensity of the returned laser beams. The reflectivity of the object may be used in step S606 to determine the emitting power level. For example, the emitting power level may be proportional to a ratio of the reflectivity of the target object and the reflectivity of the ground.

In step S618, controller 206 may determine whether all scanning angles of scanner 210 have been covered, and if not (S618: NO), method 600 proceeds to step S620 to determine and adjust the emitting power level for the next scanning angle, for example, by repeating steps S602-S618. Method 600 concludes after scanner 210 goes through all the scanning angles (S618: YES).

Although the disclosure is made using a LiDAR system as an example, the disclosed embodiments may be adapted and implemented to other types of optical sensing systems that use receivers to receive optical signals not limited to laser beams. For example, the embodiments may be readily adapted for optical imaging systems or radar detection systems that use electromagnetic waves to scan objects. Emitters and driver circuits other than those disclosed above may be used. For example, the emitter may be any other light emitter suitable for emitting the optical signals used by the respective optical sensing systems and the driver circuit may be any driver suitable to drive the respective emitter.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. An optical sensing system, comprising:
a transmitter configured to emit light beams at a plurality of vertical detection angles to scan an object;
a controller configured to dynamically vary an emitting power level of the light beams emitted at the respective vertical detection angles; and
a receiver configured to detect the light beams returned by the object.

2. The optical sensing system of claim 1, wherein the optical sensing system is a Light Detection and Ranging (LiDAR) system.

3. The optical sensing system of claim 1, wherein the transmitter further comprises an emitter configured to emit the light beams and a driver circuit configured to drive the emitter to emit the light beams at the dynamically varying emitting power level.

4. The optical sensing system of claim 3, wherein the controller is configured to supply at least one control signal to the driver circuit and the driver circuit is configured to supply a varying driver current to the emitter in response to the at least one control signal, wherein the varying driver current is proportional to the dynamically varying emitting power level.

5. The optical sensing system of claim 4, wherein the at least one control signal changes at least one of an amplitude or a pulse width of the driver current.

6. The optical sensing system of claim 3, wherein the driver circuit is an FET-controlled driver circuit or a capacitive discharge driver circuit.

7. The optical sensing system of claim 1, wherein to dynamically vary the emitting power level of the light beams, the controller is further configured to:
reduce the emitting power level when the vertical detection angle is larger than a threshold angle.

8. The optical sensing system of claim 7, wherein the threshold angle is determined based on an elevation of the optical sensing system positioned above a ground and a threshold detection distance of the optical sensing system.

9. The optical sensing system of claim 1, wherein to dynamically vary an emitting power level, the controller is further configured to:
determine detection distances of the light beams corresponding to the respective vertical detection angles; and
determine the emitting power level based on the respective detection distances.

10. The optical sensing system of claim 9, wherein the detection distances are determined based on an elevation of the optical sensing system positioned above a ground and the respective vertical detection angles.

11. The optical sensing system of claim 9, wherein the emitting power level is proportional to a square of the respective detection distances.

12. The optical sensing system of claim 1, wherein the controller is further configured to determine a first reflectivity of the object based on the light beams received by the receiver, wherein the emitting power level is proportional to a ratio of the first reflectivity and a second reflectivity of a ground.

13. A method for controlling an emitting power level in an optical sensing system, comprising:
emitting, by a transmitter, light beams at a plurality of vertical detection angles to scan an object;
dynamically varying, by a controller, the emitting power level of the light beams at the respective vertical detection angles; and
detecting, by a receiver, the light beams returned by the object.

14. The method of claim 13, further comprising reducing the emitting power level when the vertical detection angle is larger than a threshold angle, wherein the threshold angle is determined based on an elevation of the optical sensing system positioned above a ground and a threshold detection distance of the optical sensing system.

15. The method of claim 13, wherein the transmitter further comprises an emitter configured to emit the light beams and a driver circuit configured to drive the emitter,
wherein the method further comprises supplying at least control signal to the driver circuit to cause the driver circuit to supply a varying driver current to the emitter in response to the at least one control signal, wherein the varying driver current is proportional to the dynamically varying emitting power level.

16. The method of claim 13, wherein dynamically varying the emitting power level further comprises:
determining detection distances of the light beams corresponding to the respective vertical detection angles; and
determining the emitting power level based on the respective detection distances.

17. The method of claim 16, wherein the emitting power level is proportional to a square of the respective detection distances, wherein the detection distances are determined based on an elevation of the optical sensing system positioned above a ground and the respective vertical detection angles.

18. A control apparatus for controlling an emitting power level in an optical sensing system, comprising:
a driver circuit configured to drive an emitter of the optical sensing system to emit light beams, wherein the light beams are emitted at a plurality of vertical detection angles; and
a controller configured to control the driver circuit to dynamically vary the emitting power level of the light beams emitted at the respective vertical detection angles.

19. The control apparatus of claim 18, wherein the controller is further configured to supply at least one control signal to the driver circuit and the driver circuit is configured to supply a varying driver current to the emitter in response to the voltage command signal, wherein the varying driver current is proportional to the dynamically varying emitting power level.

20. The control apparatus of claim 18, wherein to dynamically control the emitting power level of the light beams, the controller is further configured to:
determine detection distances of the light beams corresponding to the respective vertical detection angles; and
determine the emitting power level based on the respective detection distances.
